(19) United States
(12) Patent Application Publication
(10) Pub. No.: US 2007/0247323 A1
(43) Pub. Date: Oct. 25, 2007

(54) Remote controller

(75) Inventors: Hirono Tsubota, Osaka (JP); Yasunari Miyake, Osaka (JP); Masahiro Takeshita, Osaka (JP); Hideki Tanabe, Osaka (JP); Yasuo Masaki, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/726,722

(22) Filed: Mar. 22, 2007

(30) Foreign Application Priority Data
Mar. 22, 2006 (JP) 2006-079166

(51) Int. Cl. G05B 19/02

(52) U.S. Cl. 340/825.22; 340/825.72; 340/3.7

(57) ABSTRACT

There is provided a remote controller capable of swiftly confirming safety of a resident without making the resident aware of being monitored by a third party, and making it difficult for an unspecified third party to know privacy of the resident. The remote controller includes an operation unit receiving an input of an instruction to an apparatus, a first and a second communications unit transmitting a signal, a storage unit storing history information including the time when the signal was transmitted and the instruction indicated by the signal, and a control unit. The control unit generates the signal indicating the instruction, detects the time, and determines whether to transmit at least a portion of the history information. When the transmission is determined, the control unit reads the portion of the history information from the storage unit, and controls the second communications unit to transmit the read information.

### BACKGROUND OF THE INVENTION

1. Field of the Invention

The present invention relates to a remote controller, and in particular to a remote controller capable of notifying occurrence of an emergency situation.

2. Description of the Background Art

Japanese Patent Laying-Open No. 2003-243189 discloses a lighting system including at least one lighting fixture, a remote controller, a main controller, and a gateway server. The remote controller controls the lighting fixture, and transmits operation information of the lighting fixture to the main controller. Upon receiving the operation information, the main controller transmits the information to the gateway server. Upon receiving the operation information, the gateway server processes the information into a predetermined format, and transmits the processed operation information to an external communications terminal.

According to the invention disclosed in Japanese Patent Laying-Open No. 2003-243189, operating states of lighting fixtures in a house or the like can be controlled at a single location, and operation of the lighting fixtures in a house, confirmation of their operating states, crime prevention, and confirmation of safety of a resident can be performed from outside, without a large-scale electric work or the like.

Japanese Patent Laying-Open No. 09-028681 discloses a safety confirmation system, including: a sensor detecting that a subject is in an unusual situation from a motion or a biological signal of the subject; an awakening unit awakening the subject by physical stimulation such as sound, vibration, or light; a confirming device driving the awakening unit according to an output of the sensor and confirming a reaction of the subject to the physical stimulation; a notifying device automatically notifying an external device at least either that the subject has no problem or that the subject is in trouble based on an output of the confirming device; and a storage device storing a history of signals input to the sensor or the confirming device and providing the history at the time of automatic notification.

According to the invention disclosed in Japanese Patent Laying-Open No. 09-028681, detailed safety information can be obtained, such as the type of an accident, the time frame during which the accident occurred, the degree of difference from the daily living pattern of a subject, and a symptom before the accident.

Japanese Patent Laying-Open No. 2002-135862 discloses a method of supplying control data supplying a remote controller with control data for operating an apparatus to be controlled. This method includes the steps of requesting control data corresponding to an apparatus to be controlled from a control data server or a computer device, and obtaining the control data corresponding to the apparatus to be controlled from the control data server or the computer device and registering the obtained control data in a remote controller.

According to the invention disclosed in Japanese Patent Laying-Open No. 2002-135862, control data for each apparatus to be controlled can readily be provided to a remote controller.

### SUMMARY OF THE INVENTION

However, in the invention disclosed in Japanese Patent Laying-Open No. 2003-243189, while safety of a resident can be confirmed from outside, there is a problem that the resident's privacy may readily be known to an unspecified third party.

According to the invention disclosed in Japanese Patent Laying-Open No. 09-028681, a problem arises that a resident tends to feel stressed by being monitored for safety by a third party.

According to the invention disclosed in Japanese Patent Laying-Open No. 2002-135862, a problem arises that it is difficult to confirm safety of a resident from outside.

The present invention has been made to solve the aforementioned problems, and one object of the present invention is to provide a remote controller capable of quickly confirming safety of a resident without making the resident aware of being monitored for safety by a third party, and making it difficult for an unspecified third party to know privacy of the resident.

In summary, a remote controller in accordance with an aspect of the present invention includes: an input unit inputting an instruction for an apparatus; a generation unit generating a control signal indicating the instruction; a transmission unit transmitting the control signal; a detection unit detecting a time; a storage unit storing history information, which is information on a time when the control signal has been transmitted and on the instruction indicated by the control signal, together with plural pieces of information indicating a plurality of respectively different destinations; a communications unit communicating information; and a control unit controlling the storage unit and the communications unit. When the communications unit receives information and a sender of the information received by the communications unit matches a specific destination which is any of the plurality of destinations, the control unit determines to transmit information corresponding to the specific destination in the history information, to the specific destination. When it is determined to transmit the information corresponding to the specific destination, the control unit reads the information corresponding to the specific destination from the memory unit, and controls the communications unit to transmit the read information.

A remote controller in accordance with another aspect of the present invention includes: an input unit inputting an instruction for an apparatus; a generation unit generating a control signal indicating the instruction; a transmission unit transmitting the control signal; a detection unit detecting a time; a storage unit storing history information, which is information on a time when the control signal has been transmitted and on the instruction indicated by the control signal; a communications unit communicating information; and a control unit controlling the storage unit and the communications unit. The control unit determines whether to transmit at least a portion of the history information, and when it is determined to transmit at least a portion of the history information, the control unit reads at least a portion of the history information from the memory unit, and controls the communications unit to transmit the read portion of the history information.

Preferably, the storage unit stores the history information together with information indicating a destination. When the communications unit receives information, the control unit determines whether to transmit at least a portion of the history. information based on whether a sender of the information received by the communications unit matches the destination.

Preferably, the storage unit stores the history information together with plural pieces of information indicating a plurality of respectively different destinations. When the sender of the information received by the communications unit matches a specific destination which is any of the plurality of destinations, the control unit determines to transmit information corresponding to the specific destination in the history information, to the specific destination.

Preferably, when the communications unit receives information, the control unit determines whether to transmit information indicating the latest information in the history information, and reads the information indicating the latest information.

Preferably, the control unit determines whether to transmit at least a portion of the history information based on the time detected by the detection unit.

According to still another aspect of the present invention, a remote controller controlling an apparatus is provided. The remote controller includes: an input unit accepting a direction input for the remote controller; a generation unit generating a control signal giving an instruction to the apparatus based on the direction input; a transmission unit transmitting the control signal; a storage unit storing a time when the control signal has been transmitted and information indicated by the instruction; a communications unit communicating information; and a control unit causing the communications unit to transmit at least one of the time and the information stored in the storage unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a conceptual view showing a role of a remote controller in accordance with an embodiment of the present invention.

FIG. 2 is a conceptual view showing devices built in the remote controller in accordance with the embodiment of the present invention.

FIG. 3 is a control block diagram showing hardware for implementing the remote controller in accordance with the embodiment of the present invention.

FIG. 4 is a conceptual view of history information stored in a storage unit in accordance with the embodiment of the present invention.

FIG. 5 is a flow chart illustrating a procedure for control of a process for transmitting the history information in accordance with the embodiment of the present invention.

### DESCRIPTION OF THE PREFERRED EMBODIMENTS

Hereinafter, an embodiment of the present invention will be described with reference to the drawings. In the description below, identical parts will be designated by the same reference characters. Since they have the same names and functions, detailed description thereof will not be repeated.

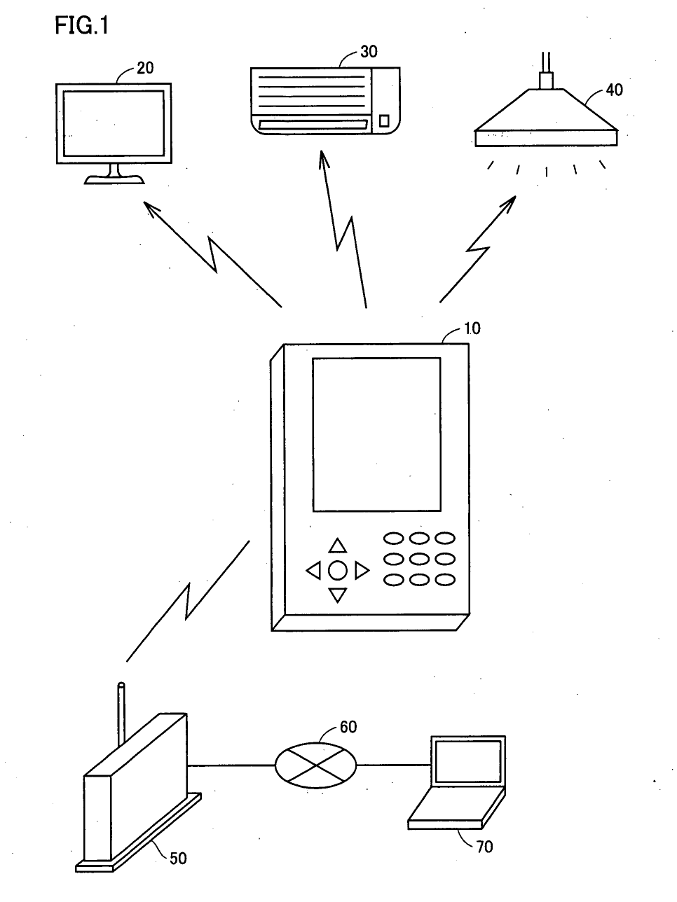

Referring to FIG. 1, a remote controller 10 transmits a control signal to an apparatus. In the present embodiment, the “apparatus” refers to an apparatus controlled by the control signal transmitted by remote controller 10. A television set 20, an air conditioner 30, or a lighting fixture 40 is an example of the “apparatus”. The apparatus which has received the control signal operates according to the control signal. Remote controller 10 also serves as a device transmitting history information described later to a LAN (Local Area Network) modem 50. Information transmitted to LAN modem 50 is transmitted via a communications network 60 to a personal computer 70.

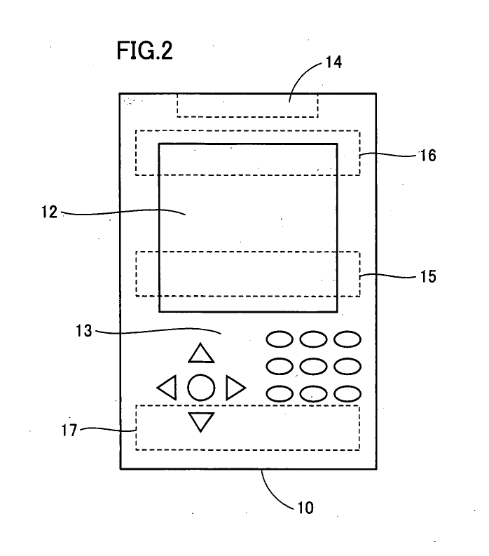

Referring to FIG. 2, remote controller 10 in accordance with the present embodiment includes a display unit 12, an operation unit 13, a first communications unit 14, a storage unit 15, a control unit 16, and a second communications unit 17. Display unit 12 is a device displaying information. In the present embodiment, display unit 12 is a touch panel. Operation unit 13 is a device through which a user inputs information. One type of information input by a user is information indicating a destination. History information described later is transmitted to the destination. The first communications unit 14 communicates with an apparatus with infrared radiation. Storage unit 15 stores information. A first type of information stored in storage unit 15 is plural pieces of information indicating respectively different destinations. A second type of information stored in storage unit 15 is history information. In the present embodiment, the “history information” refers to information on a time when the first communications unit 14 has transmitted a control signal and on an instruction indicated by the control signal transmitted by the first communications unit 14. In the present embodiment, each piece of information constituting the history information corresponds to the information indicating a destination. The “destination” refers to a location to which the history information is transmitted. In the present embodiment, the history information is deleted when two weeks have passed from the day on which remote controller 10 operated the apparatus. Control unit 16 controls each unit of remote controller 10. The second communications unit 17 communicates information as a signal with a protocol different from that used in the first communications unit 14. The protocol used for communications is not particularly limited. Examples of the protocol include Bluetooth (trademark), PCL (Printer Control Language), and the like. In the present embodiment, the second communications unit 17 communicates information in conformity with IEEE (The Institute of Electrical and Electronics Engineers Incorporated) 802.11b.

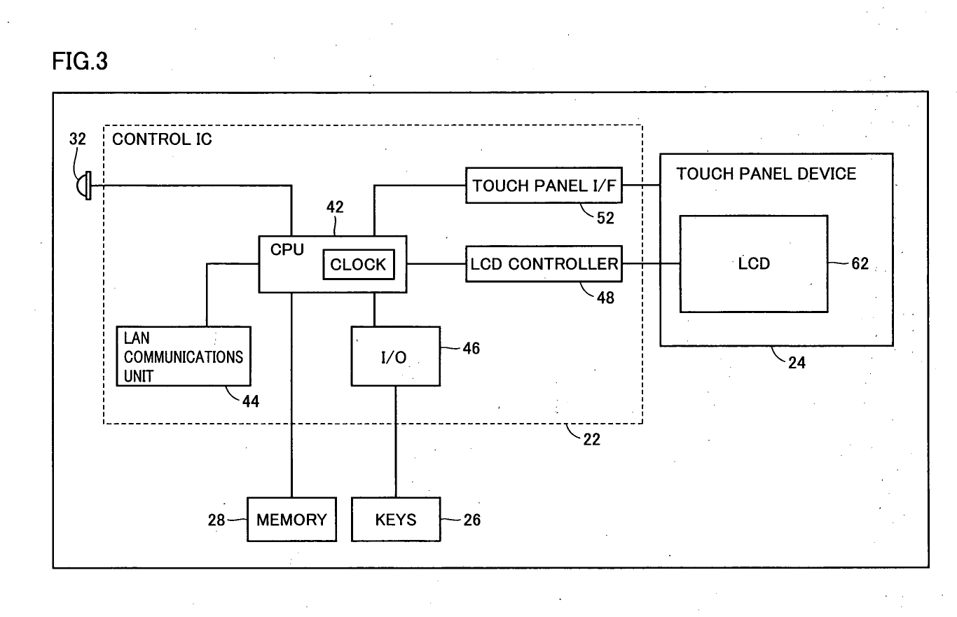

Referring to FIG. 3, hardware of remote controller 10 includes a control IC 22, a touch panel device 24, keys 26, a memory 28, and an LED (Light Emitting Diode) 32. Control IC 22 controls each unit of remote controller 10. Touch panel device 24 displays information and accepts a direction from a user. Besides touch panel device 24, keys 26 also accept a direction and information from a user. Memory 28 is a device storing information. LED 32 is a device transmitting a signal by infrared radiation.

Control IC 22 includes a CPU (Central Processing Unit) 42, a LAN communications unit 44, an I/O (Input/Output) 46, an LCD (Liquid Crystal Display) controller 48, and a touch panel interface 52. CPU 42 controls each unit of control IC 22. CPU 42 also serves as a device performing computation required for the control. LAN communications unit 44 is a device communicating with LAN modem 50. I/O 46 is a device communicating a signal with keys 26. LCD controller 48 generates a signal for controlling an LCD 62 described later. Touch panel interface 52 controls touch panel device 24.

Touch panel device 24 includes LCD 62. LCD 62 displays information. LCD 62 also serves as a device detecting that a user has touched it with his or her finger. When LCD 62 detects that a user has touched it with his or her finger, LCD 62 transmits to LCD controller 48 a signal corresponding to a location touched by the user.

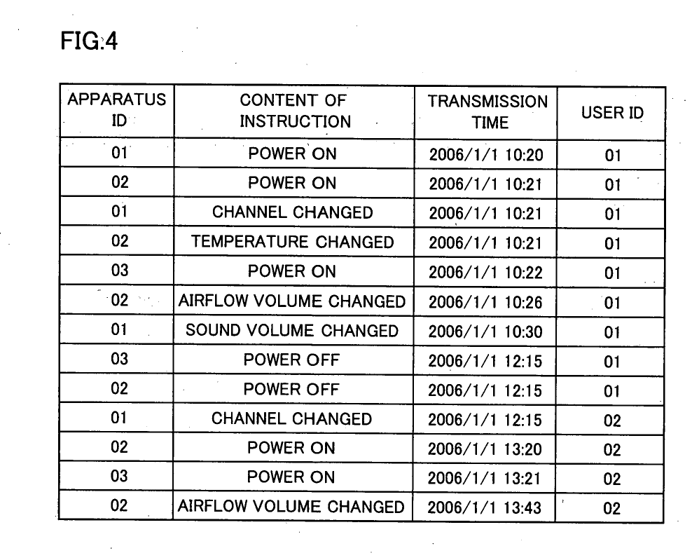

FIG. 4 is a conceptual view of the history information stored in memory 28 as storage unit 15. Referring to FIG. 4, the history information includes information indicating an apparatus ID, information indicating the content of an instruction, information indicating a transmission time, and information indicating a user ID. The information indicating an apparatus ID indicates an ID specific to each apparatus. The information indicating the content of an instruction is information on the instruction indicated by a control signal transmitted by the first communications unit 14. The information indicating a transmission time is information indicating a time when the first communications unit 14 has transmitted a control signal. The information indicating a user ID indicates an ID specific to a user operating remote controller 10.

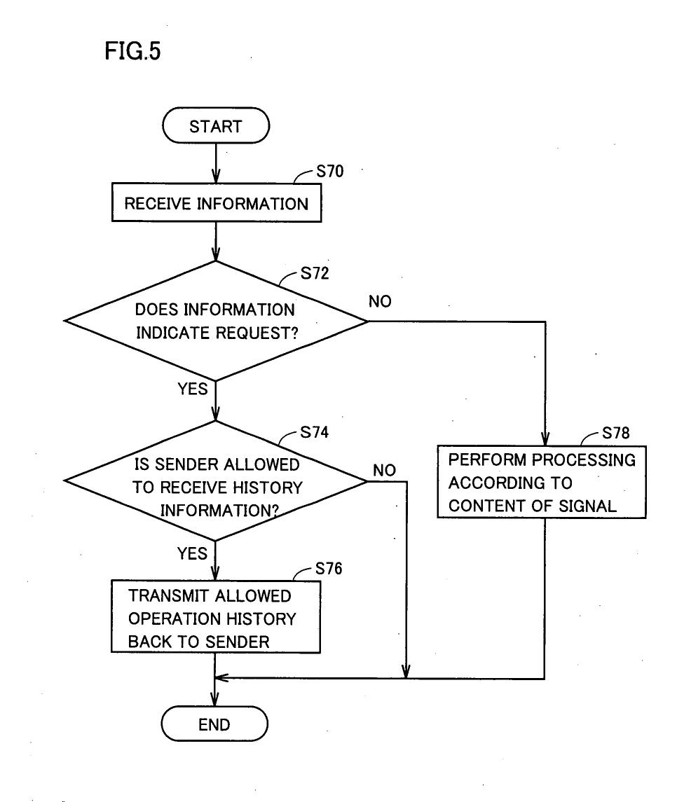

Referring to FIG. 5, a program executed in remote controller 10 performs control of a process for transmitting the history information as described below.

In step S70, LAN communications unit 44 operating as the second communications unit 17 receives information from personal computer 70 via LAN. modem 50.

In step S72, CPU 42 operating as control unit 16 determines whether the information received by LAN communications unit 44 indicates a request for the history information. In this step, LAN communications unit 44 operates as the second communications unit 17. Thereby, CPU 42 can determine whether LAN communications unit 44 has received information indicating a request for the history information. If CPU 42 determines that the information received by LAN communications unit 44 indicates a request for the history information (YES in step S72), the process proceeds to step S74. If CPU 42 determines that the information received by LAN communications unit 44 does not indicate a request for the history information (NO in step S72), the process proceeds to step S78.

In step S74, CPU 42 determines whether a sender of the information received by LAN communications unit 44, that is, personal computer 70, is allowed to receive the history information. In this step, LAN communications unit 44 operates as the second communications unit 17. In the present embodiment, CPU 42 determines whether the sender of the information received by LAN communications unit 44 is allowed to receive the history information, by determining whether the sender matches a specific destination which is any of a plurality of senders. The “plurality of senders” are indicated by information stored in memory 28 operating as storage unit 15. If CPU 42 determines that the sender is allowed to receive the history information (YES in step S74), the process proceeds to step S76. Thereby, CPU 42 determines to transmit information corresponding to the specific destination in the history information, to the specific destination. If CPU 42 determines that the sender is not allowed to receive the history information (NO in step S74), the process ends.

In step S76, CPU 42 reads from memory 28 the information corresponding to the specific destination in the history information. When the information is read, LAN communications unit 44 operating as the second communications unit 17 transmits the information read by CPU 42 to personal computer 70 via LAN modem 50, under the control of CPU 42. Thereby, the information transmitted to personal computer 70 becomes information allowed to be disclosed to personal computer 70. The type of the information transmitted back to personal computer 70 is not particularly limited. The information may be transmitted for example in the form of an E-mail or stream data. In the present embodiment, information indicating operation history is transmitted back as a packet.

In step S78, CPU 42 performs processing according to the content of a signal received by the second communications unit 17.

A description will now be given of the operation of remote controller 10 based on the structure and the flow chart as described above.

A user inputs an instruction for an apparatus through keys 26 operating as operation unit 13. When the instruction is input, CPU 42 operating as control unit 16 generates a control signal indicating the instruction. When the control signal is generated, LED 32 operating as the first communications unit 14 transmits the control signal with blinking infrared light. Simultaneously with the transmission of the control signal, memory 28 operating as storage unit 15 stores history information. To store the history information, it is necessary to detect a time when the first communications unit 14 has transmitted the control signal. The time is detected by a clock built in CPU 42. By repeating the process from the input through operation unit 13 to the storage of the history information, plural pieces of history information are stored in memory 28.

Thereafter, LAN communications unit 44 receives information from personal computer 70 (step S70). When a signal is received, CPU 42 determines whether the information received by LAN communications unit 44 indicates a request for the history information (step S72). If the information indicates a request for the history information in this case (YES in step S72), CPU 42 determines whether a sender of the signal is allowed to receive the history information (step S74). If the sender is allowed to receive the history information in this case (YES in step S74), LAN communications unit 44 tranrismits the history information allowed to be disclosed to personal computer 70, that is, allowed for the sender (step S76).

In this manner, the remote controller in accordance with the present embodiment transmits operation history upon request of a predetermined destination. Since the information is transmitted upon the request of the predetermined destination, it is difficult for an unspecified third party to view the information. As a result, a remote controller capable of quickly confirming safety of a resident without making the resident aware of being monitored for safety by a third party, and making it difficult for an unspecified third party to know privacy of the resident can be provided. When the predetermined destination is a friend or close relative of the resident, a safety monitoring system is implemented. If friends communicate information on operation history with each other, a system which allows them to monitor each other's condition is implemented.

Further, the remote controller in accordance with the present embodiment transmits information corresponding to a specific destination, to the specific destination. This allows transmission of information corresponding to a destination. When information corresponding to a destination is transmitted, privacy of a resident can be protected to a maximum extent.

Further, the remote controller in accordance with the present embodiment transmits history information when a sender of information requesting history information matches a destination stored beforehand in a memory as information. This facilitates addition or change of a destination of history information after the remote controller comes into use. Since addition or change of a destination is facilitated, there is no need to set a destination at the time of fabricating the remote controller. Since there is no need to set a destination at the time of fabricating the remote controller, fabrication of a versatile remote controller is facilitated, which facilitates fabrication of a remote controller in an inexpensive manner. As a result, a remote controller capable of quickly confirming safety of a resident without making the resident aware of being monitored for safety by a third party, and making it difficult for an unspecified third party to know privacy of the resident can be provided inexpensively.

It is to be noted that CPU 42 of remote controller 10 in accordance with a first variation of the present embodiment may determine in step S74 whether to transmit at least a portion of the history information. In this case, whether personal computer 70 is allowed to receive the history information does not have to be determined. In this case, memory 28 just has to store the history information. In this case, if CPU 42 itself determines to transmit at least a portion of the history information, CPU 42 reads from memory 28 at least a portion of the history information in step S76. Since whether to transmit at least a portion of the history information is determined, there may arise a case where the history information is not transmitted, which enhances difficulty for an unspecified third party to know privacy of a resident. The factor serving as a basis for determining whether to transmit at least a portion of the history information is not particularly limited. Examples of a method of such determination include a method based on a time detected by the clock in CPU 42. When whether to transmit at least a portion of the history information is determined based on a time, the history information is transmitted regardless of whether a sender requests the history information, which makes it easier to specify the time when something. unusual happened to the resident.

Further, CPU 42 of remote controller 10 in accordance with a second variation of the present embodiment may determine in step S72 whether information has been received from any apparatus, instead of determining whether the received information indicates a request for the history information. Examples of “any apparatus” described herein include a GPS (Global Positioning System) satellite, which is a satellite constituting a GPS.

Further, CPU 42 of remote controller 10 in accordance with a third variation of the present embodiment may determine in step S74 whether to transmit information indicating the latest transmission in the history information. If CPU 42 determines to transmit information. indicating the latest transmission in the history information in this case, CPU 42 reads from memory 28 the information indicating the latest transmission in the history information in step S76. In this case, LAN communications unit 44 operating as the second communications unit 17 transmits the information read by CPU 42 to personal computer 70 via LAN modem 50, under the control of CPU 42. Since the information indicating the latest transmission is transmitted, information traffic is reduced, and thus a remote controller which allows a third party to quickly find that something unusual happened to a resident can be provided.

It is to be noted that memory 28 in accordance with a fourth variation of the present embodiment may store the history information together with information indicating one destination. In this case, when LAN communications unit 44 receives information, CPU 42 determines whether to transmit at least a portion of the history information based on whether a sender of the information received by LAN communications unit 44 matches a destination stored in memory 28 as information.

Although the present invention has been described and illustrated in detail it is clearly understood that the same is by way of illustration and example only and is not to be taken by way of limitation, the spirit and scope of the present invention being limited only by the terms of the appended claims.

What is claimed is:

1. A remote controller, comprising:
an input unit inputting an instruction for an apparatus;
a generation unit generating a control signal indicating said instruction;
a transmission unit transmitting said control signal;
a detection unit detecting a time;
a storage unit storing history information, which is information on a time when said control signal has been transmitted and on said instruction indicated by said control signal, together with plural pieces of information indicating a plurality of respectively different destinations;
a communications unit communicating information; and
a control unit controlling said storage unit and said communications unit,
wherein, when said communications unit receives information and a sender of the information received by said communications unit matches a specific destination which is any of said plurality of destinations, said control unit determines to transmit information corresponding to said specific destination in said history information, to said specific destination, and
when it is determined to transmit the information corresponding to said specific destination, said control unit reads the information corresponding to said specific destination from said memory unit, and controls said communications unit to transmit said read information.

2. A remote controller, comprising:
an input unit inputting an instruction for an apparatus;
a generation unit generating a control signal indicating said instruction;
a transmission unit transmitting said control signal;
a detection unit detecting a time;
a storage unit storing history information, which is information on a time when said control signal has been transmitted and on said instruction indicated by said control signal;
a communications unit communicating information; and
a control unit controlling said storage unit and said communications unit,
wherein said control unit determines whether to transmit at least a portion of said history information, and
when it is determined to transmit at least a portion of said history information, said control unit reads at least a portion of said history information from said memory unit, and controls said communications unit to transmit said read portion of said history information.

3. The remote controller according to claim 2, wherein
said storage unit stores said history information together with information indicating a destination, and
when said communications unit receives information, said control unit determines whether to transmit at least a portion of said history information based on whether a sender of the information received by said communications unit matches said destination.

4. The remote controller according to claim 3, wherein
said storage unit stores said history information together with plural pieces of information indicating a plurality of respectively different destinations, and
when the sender of the information received by said communications unit matches a specific destination which is any of said plurality of destinations, said control unit determines to transmit information corresponding to said specific destination in said history information, to said specific destination.

5. The remote controller according to claim 2, wherein, when said communications unit receives information, said control unit determines whether to transmit information indicating the latest information in said history information, and reads said information indicating the latest information.

6. The remote controller according to claim 2, wherein said control unit determines whether to transmit at least a portion of said history information based on the time detected by said detection unit.

7. A remote controller controlling an apparatus, comprising:
an input unit accepting a direction input for said remote controller;
a generation unit generating a control signal giving an instruction to said apparatus based on said direction input;
a transmission unit transmitting said control signal;
a storage unit storing a time data when said control signal has been transmitted and information indicated by said instruction;
a communications unit communicating information; and
a control unit causing said communications unit to transmit at least one of said time data and said information stored in said storage unit.
